(19) United States
(12) Patent Application Publication
(10) Pub. No.: US 2023/0021576 A1
(43) Pub. Date: Jan. 26, 2023

(54) MULTIPLEXED COHERENT OPTICAL PHASED ARRAY IN A LIGHT DETECTION AND RANGING (LiDAR) SYSTEM

(71) Applicant: Seagate Technology LLC, Fremont, CA (US)

(72) Inventors: Daniel Joseph Klemme, Robbinsdale, MN (US); Aditya Jain, Minneapolis, MN (US)

(21) Appl. No.: 17/868,906

(22) Filed: Jul. 20, 2022

Related U.S. Application Data
(60) Provisional application No. 63/223,596, filed on Jul. 20, 2021.

(51) Int. Cl. G01S 7/481; G01S 17/26; G02B 6/12; G01S 7/4914

(52) U.S. Cl. CPC G01S 7/4817; G01S 17/26; G01S 7/4814; G02B 6/12033; G01S 7/4914

(57) ABSTRACT

Method and apparatus for enhancing resolution in a light detection and ranging (LiDAR) system. In some embodiments, an emitter emits light in the form of multiplexed beams of randomized, multiple wavelengths across a field of view (FoV). A detector uses one or more detection channels to detect the multiplexed beams reflected from a target within the FoV to decode range information associated with the target. The multiplexed beams may be generated by multiple light sources such as laser diodes, or a single source such as a frequency comb device. Randomization may be applied via a pseudorandom bit sequence modulator, and multiplexing/demultiplexing may be performed using waveguides and micro-resonance rings (MRRs). The multiplexed beam may be emitted using an optical phase array (OPA) integrated circuit device to scan the FoV simultaneously using the different wavelengths. The range information can be used to adaptively adjust the wavelengths in a subsequent scan.

### RELATED APPLICATION

The present application makes a claim of domestic priority to U.S. Provisional Patent Application No. 63/223,596 filed Jul. 20, 2021, the contents of which are hereby incorporated by reference.

### SUMMARY

Various embodiments of the present disclosure are generally directed to the use of multiplexed wavelengths of light in an optical phase array.

Without limitation, in some embodiments an emitter emits light in the form of multiplexed beams of randomized, multiple wavelengths across a field of view (FoV). A detector uses one or more detection channels to detect the multiplexed beams reflected from a target within the FoV to decode range information associated with the target.

The multiplexed beams can be generated by multiple light sources such as laser diodes, or a single source such as a frequency comb device. Randomization can be applied via a pseudorandom bit sequence (PRBS) modulator. Multiplexing and demultiplexing of the beams can be performed using waveguides and micro-resonance rings (MRRs). The multiplexed beams may be emitted using an optical phase array (OPA) integrated circuit (IC) device to scan the FoV using the different wavelengths. The range information obtained from a first scan can be used to adaptively adjust the wavelengths that are used in a subsequent scan.

These and other features and advantages of various embodiments can be understood from the following detailed description in conjunction with a review of the accompanying drawings.

### BRIEF DESCRIPTION OF THE DRAWINGS

FIG. 1 is a functional block representation of a light detection and ranging (LiDAR) system constructed and operated in accordance with various embodiments.

FIG. 2 shows an emitter that can be incorporated into the system of FIG. 1 in some embodiments.

FIG. 3 shows an optical phase array (OPA) that can be used in conjunction with the emitter of FIG. 2.

FIG. 4 shows a detector that can be incorporated into the system of FIG. 1 in some embodiments.

FIGS. 5A, 5B and 5C show different scanning arrangements that can be utilized in some embodiments.

FIG. 6 depicts a multiplexing arrangement in accordance with some embodiments.

FIG. 7 shows another multiplexing arrangement in accordance with some embodiments.

FIG. 8 illustrates the use of another arrangement to generate multiple wavelengths in some embodiments.

FIG. 9 shows yet another arrangement in some embodiments.

FIGS. 10A and 10B respectively show a multiplexing and demultiplexing scheme based on wavelength in some embodiments.

FIG. 11 shows transmitted and received pulses by the system in some embodiments.

FIG. 12 is a multiwavelength scan operational sequence carried out in accordance with some embodiments.

FIG. 13 shows an adaptive OPA management system constructed and operated in accordance with further embodiments.

### DETAILED DESCRIPTION

Various embodiments of the present disclosure are generally directed to enhancing transmission and detection efficiencies of an active light detection system.

Light Detection and Ranging (LiDAR) systems are useful in a number of applications in which range information (e.g., distance, etc.) is obtained by irradiating a target and detecting reflected light (or other electromagnetic energy) therefrom. While not limiting, the light wavelengths used in a typical LiDAR system may vary from ultraviolet to near infrared (e.g., 250 nanometers, nm to 1500 nm or more). Other wavelength ranges can be used. Light is a particularly useful transport mechanism for sensing and decoding target range information.

An optical phased array (OPA) is a well-known mechanism that provides solid-state scanning of a beam of light purely through electronics, that is, without any moving mechanical parts. OPAs can be configured to scan in a single axial direction (e.g., along a first axis such as a horizontal x-axis) or in multiple orthogonal directions (e.g., along orthogonal, horizontal x-axis and vertical y-axis directions). In some cases, a beam from a single source can be manipulated by a single or multi-stage OPA structure to provide multi-axial rasterized scanning. Other output systems are known in the art, however, including rotatable polygons, galvanometer based systems, micromirror technology systems, etc. that employ some measure of mechanical operation to direct the LiDAR beams.

Coherent detection is a technique that can be used in LiDAR to boost the signal to noise ratio (SNR) of a given light return signal. Coherent detection operates by causing the reflected light signal to induce modulations on a highly sensitive optical local oscillator. The received beam is processed by splitting off a fraction of the emitted laser light to a separate arm of the system prior to being forwarded to the scanner (emitter) stage. Generally, the strength of the oscillations is proportional to the square root of the local oscillator power, and the shot noise induced by the local oscillator is proportional to the square root of local oscillator power.

By increasing the light power in the local oscillator, other noise sources can be overwhelmed, which increases the SNR of the system up until the shot noise becomes dominant. At this point, the SNR gains saturate the receiver with respect to local oscillator power. In this way, coherent LiDAR systems enable the physical limit of SNR to be reached rather than the noise inherent in the particular detector choice. This in turn enables detection of longer-range targets, because less light is required to make a detection vs. time of flight systems. Coherent detection is thus a suitable match for a solid state scanning mechanism such as an OPA, because many of the components required in coherent detection techniques (e.g. modulators, optical mixers, photodetectors) can be cheaply integrated on a single integrated circuit device (chip).

Regardless of system configuration, long-range LiDAR systems present a number of challenges. One problem associated with long-range LiDAR operation relates to the fact that the greater the distance to the target, the longer it will take for light pulses to travel downrange to the target and then back to the detector. For long range targets such as on the order of 150 meters (m) or greater from the LiDAR system, the total travel time (referred to as time of flight, or ToF) for the various pulses emitted by the emitter and detected by the detector can be greater than 1 microsecond, us (1×10⁻⁶ secs).

While not limiting, it is often desirable that the LiDAR system generate a certain total number of points per second (pts/sec) in order to generate an accurate point cloud representation of the surrounding environment. For reference, each “point” can be viewed as the beam width response of the emitted pulses over an associated field of view (FoV), which is often (but not always) rasterized over a given set of orthogonal axes (such as an x-y viewing area of selected size).

One commonly specified threshold used in many LiDAR systems is that a minimum of 1 million, M (1×10⁶) points be generated per second. Other specified values can be used, including values greater or less than this threshold value. If at least some points are taking more than 1 millionth of a second to return to the detector (e.g., ToFs>1 us), it can be difficult to obtain a minimum threshold resolution of 1M pts/sec on a recurring basis (e.g., each frame of rasterized scanning pattern sent downrange). One way to address long-range LiDAR is to provide additional detection channels that can be used to detect the “slower” timed pulses from the downstream targets.

Another problem associated with long-range LiDAR detection is that not all range information obtained from the system may be based on ToF. Rather, some detection mechanisms may utilize other features, such as integration of the received signals over some period of time. Longer integration times will tend to increase the SNR of the system, as the minimum detectable power is proportional to log(T)/T, where T is the integration time. If the travel time of the light starts to approach the integration time for a single point, then the SNR of the coherent LiDAR system will more rapidly start to decrease. Conversely, each simultaneous channel that can be added can increase the integration time and therefore increase the SNR.

An additional problem for long-range LiDAR is that it can be difficult to scale the output power, as silicon-based waveguides can usually accommodate, at best, a few tens of milliwatts, mW (10⁻³ watts) of power at a given wavelength before two-photon effects become significant and cause excess loss. However, increasing the output power will tend to increase the number of photons that return to the device and therefore will increase the maximum range. Nitride-based waveguides can be used instead to increase the power at the cost of increased device footprint, or the power can be spread across multiple wavelengths which will not generate two-photon losses between each other.

Various embodiments of the present disclosure are accordingly directed to a novel wavelength multiplexing LiDAR scheme, in which multiple channels are separated in the space of multiple wavelengths. As explained below, some embodiments provide an OPA-based LiDAR system that scans at least one dimension. A single dimension is not necessarily limiting, as various alternatives can scan in multiple dimensions (such as but not limited to orthogonal x and y axes, etc.). The multi-axial scanning can be carried out by a single OPA or multiple OPA devices.

Multiple simultaneous wavelengths are used to transform a single-point scan into a fan of multiple beams. Without limitation, the general idea is to scan multiple angles simultaneously by feeding multiple wavelengths into the OPA, and then detecting each of them simultaneously at a detector stage that incorporates one or more detection channels.

A number of ways to generate multiple wavelengths simultaneously are proposed and are discussed in detail below. One way is to use multiple input sources (e.g., lasers, etc.), each of which is tuned to a separate frequency/wavelength and fed into the OPA device. Another alternative is to use a pseudorandom binary sequence (PRBS) pattern to modulate each of a number of different wavelength channels. Yet another alternative is to use a frequency comb laser arrangement to generate the multiple wavelengths from a single device. It will be appreciated that frequency f is inversely related to wavelength λ, such as via the relation f=c/λ where c is the speed of light (e.g., about 3×10⁸ m/s).

Regardless of the approach used, an advantage of multiple wavelength-separated beams in coherent LiDAR as disclosed herein is that the integration time can be increased. This will increase the dwell time on a particular point and will enable higher range distances, since the system can afford to wait longer for the light to travel to and from a target that is potentially hundreds of meters away.

Further advantages of various embodiments include the fact that a higher effective power can be transmitted through the system because the power is spread throughout the optical spectrum which will not produce lossy two-photon effects.

Still further advantages include the fact that some of the requirements on the scanning lasers can be relaxed, since in the case where multiple lasers are used, the system will only require lasers that can wavelength scan over a relatively small spectrum such as, for example, around 5 to 10 nanometers, nm (10⁻¹² m) vs. a single laser that has the capability of scanning over a larger spectrum such as, for example around 60 to 100 nm.

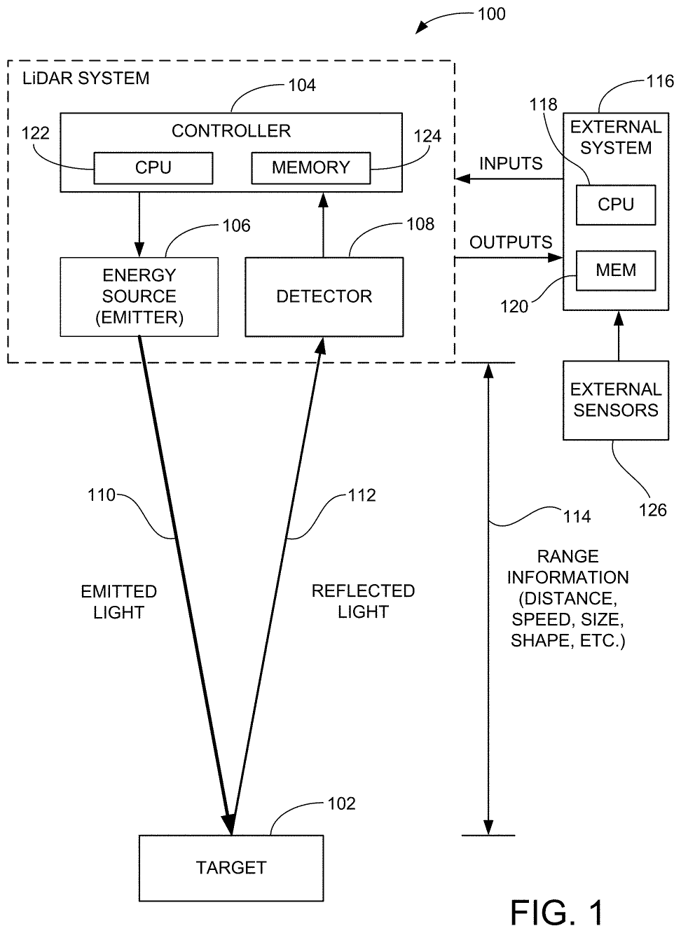

These and other features and advantages of various embodiments can be understood beginning with a review of FIG. 1 which shows a simplified functional representation of a LiDAR system 100 constructed and operated in accordance with various embodiments of the present disclosure. The LiDAR system 100 is configured to obtain range information regarding a target 102 that is located distal from the system 100.

The information derived by the system 100 can be beneficial in a number of areas and applications including, but not limited to, topography, archeology, geology, surveying, geography, forestry, seismology, atmospheric physics, laser guidance, automated driving and guidance systems, closed-loop control systems, etc.

The LiDAR system 100 includes a controller 104 which provides top level control of the system. The controller 104 can take any number of desired configurations, including hardware and/or software. In some cases, the controller 104 can include the use of one or more programmable processors with associated programming (e.g., software, firmware) stored in a local memory which provides instructions that are executed by the programmable processor(s) during operation. Other forms of controllers can be used, including hardware based controllers, digital signal processors (DSPs), field programmable gate arrays (FPGAs), system on chip

(SOC) integrated circuits, application specific integrated circuits (ASICs), gate logic, reduced instruction set computers (RISCs), etc.

An energy source circuit 106, also sometimes referred to as an emitter or a transmitter, operates to direct electromagnetic radiation in the form of light pulses toward the target 102. A detector circuit 108, also sometimes referred to as a receiver or a sensor, senses reflected light pulses received back from the target 102. The controller 104 directs operation of the emitted light from the emitter 106, denoted by arrow 110, and decodes information from the reflected light obtained back from the target, as denoted by arrow 112.

Arrow 114 depicts the actual, true range information associated with the intervening distance (or other range parameter) between the LiDAR system 100 and the target 102. Depending on the configuration of the system, the range information can include but is not limited to the relative or absolute speed, velocity, acceleration, distance, size, location, reflectivity, color, surface features and/or other characteristics of the target 102 with respect to the system 100.

The decoded range information can be used to carry out any number of useful operations, such as controlling a motion, input or response of an autonomous vehicle, generating a topographical map, recording data into a data structure for further analysis and/or operations, etc. The controller 104 can perform these operations directly, or can communicate the range information to an external system 116 for further processing and/or use.

In some cases, inputs supplied by the external system 116 can activate and configure the system to capture particular range information, which is then returned to the external system 116 by the controller 104. The external system can take any number of suitable forms, and may include a system controller (such as CPU 118), local memory 120, etc. The external system may form a portion of a closed-loop control system and the range information output by the LiDAR system 100 can be used by the external system 116 to adjust the position of a moveable element.

The controller 104 can incorporate one or more programmable processors (CPU) 122 that execute program instructions in the form of software/firmware stored in a local memory 124, and which communicate with the external controller 118.

External sensors 126 can provide further inputs used by the external system 116 and/or the LiDAR system 100. The external sensors 126 can take substantially any useful form including but not limited to geopositioning systems (e.g., global positioning systems, GPS), networked inputs and/or inputs from external systems, accelerometers, proximity sensors, speedometers, temperature or other environmental sensors, map databases, RFID sensors, etc. One or more of the external sensors 126 may operate to provide an input that changes an operational configuration of the system 100 to account for an environment detected by the one or more sensors.

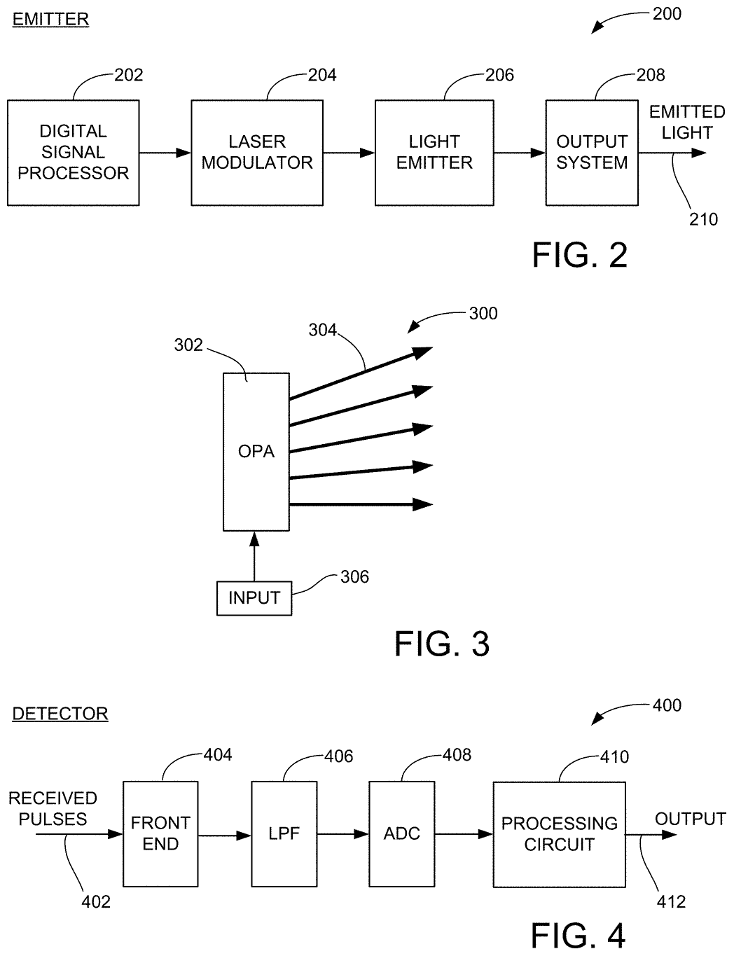

FIG. 2 depicts an emitter circuit 200 incorporated into the system 100 of FIG. 1 in some embodiments. Other arrangements can be used so the configuration of FIG. 2 is merely illustrative and is not limiting. The emitter circuit 200 includes a digital signal processor (DSP) 202 that provides adjusted inputs to a laser modulator 204, which in turn adjusts a light emitter (e.g., one or more lasers, laser diodes, etc.) 206 to emit electromagnetic radiation (e.g. light) in a desired spectrum.

The emitted light is processed by an output system 208 to issue one or more beams of emitted light 210. The light may be in the form of pulses, coherent light, non-coherent light, swept light, etc. The light modulator 204 may incorporate a single light emitting device or multiple devices each configured to output light over different wavelengths or other specified characteristics.

FIG. 3 is an output system 300 used by the system of FIG. 2 in some embodiments. Other arrangements can be used. The system 300 includes an optical phase array (OPA) device 302 that outputs an array of light beams 304 at controllably directed angles responsive to inputs supplied by an upstream input device 306. The OPA 302 is a solid-state device so that no mechanical operation or manipulation is required to controllably direct the light beams 304.

FIG. 4 provides a generalized representation of a detector circuit 400 configured to process reflected light issued by the system 200 of FIG. 2 and output system 300 of FIG. 3. As before, the circuitry in FIG. 4 is incorporated into the system 100 of FIG. 1 in some embodiments. The detector circuit 400 receives reflected pulses 402 which are processed by a suitable front end 404. The front end 404 can include optics, detector grids, amplifiers, mixers, and other suitable features to present input pulses reflected from the target.

A low pass filter (LPF) 406 and an analog to digital converter (ADC) 408 are not required but can be used to provide processing of the input pulses. A processing circuit 410 provides suitable signal processing operations to generate a useful output 412. While a single detection channel is denoted, it will be understood that multiple channels, including quadrature I/Q channels, can be utilized as part of the decoder circuitry 400. The decoder is configured to receive and process multiple wavelengths simultaneously from the received input pulses 402.

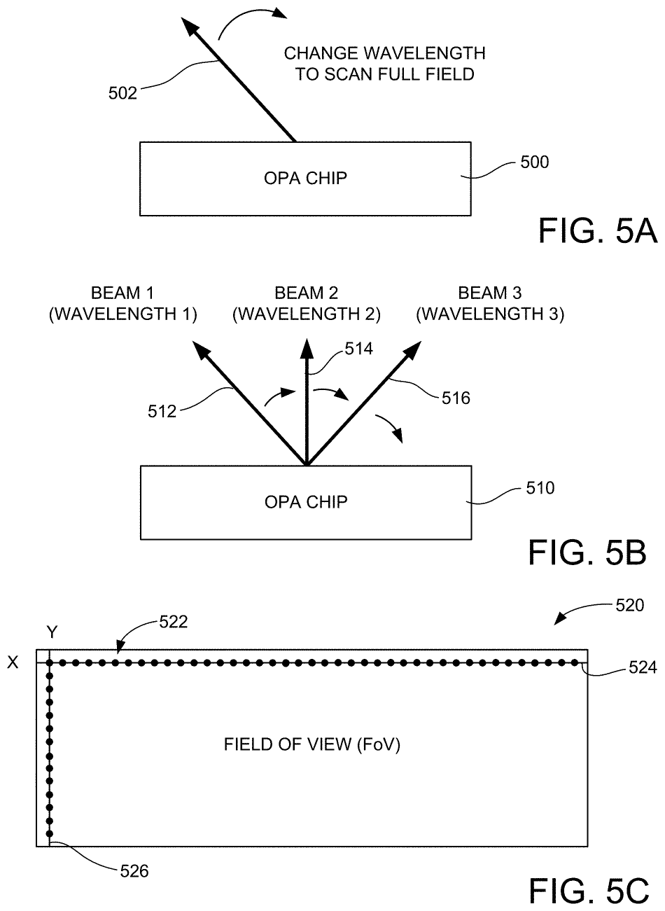

The multiple wavelengths of the emitted signals output and received by the various systems in FIGS. 2-4 can be generated such as described in FIGS. 5A through 5C. FIG. 5A shows an OPA chip (integrated circuit, IC) 500 that scans a light beam 502 over a selected field of view (FoV). During the scan, different wavelengths are used for the respective beam points across the FoV.

FIG. 5B shows another OPA chip 510 that uses three different beams 512, 514 and 516 to provide different wavelengths of light that scan different portions of the FoV. Other numbers and arrangements of beams can be used.

FIG. 5C shows a selected FoV 520 scanned by beam points 522 along multiple x and y axes 524, 526. The scanning by the OPA arrangements set forth herein can be along a single dimension (e.g., x-axis, y-axis) or along multiple orthogonal axes.

FIGS. 5A-5C show the overall scanning scheme employed by various embodiments of the present disclosure. One or more OPA chips such as 500, 510 each provide a single beam that is scanned in one or more dimensions, with at least one of the dimensions controlled by wavelength. The disclosed operation feeds the associated OPA with multiple wavelengths, which will then fan out into different beam angles, and each beam can be scanned via smaller changes in wavelength to ensure the entire field of view is covered. The challenge becomes one of generating multiple wavelengths and multiplexing/demultiplexing properly on the chip so that each wavelength channel can produce the desired range measurements.

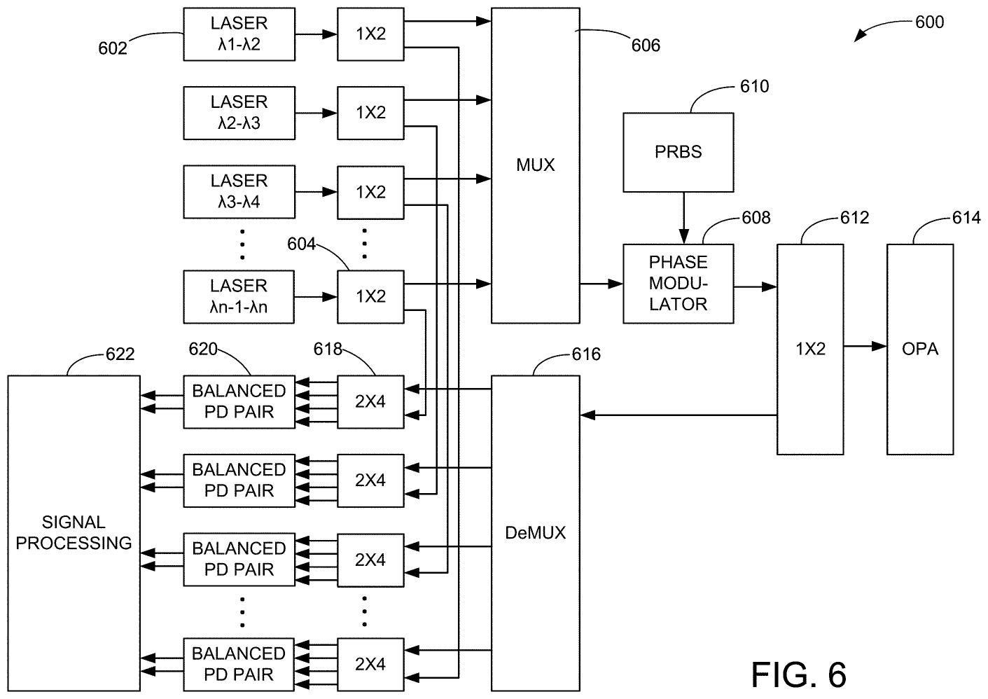

Multiple wavelengths can be generated and output simultaneously in a number of ways. FIG. 6 shows an emitter and detector circuit 600 that uses multiple lasers 602 each tuned to a separate wavelength/range and which are fed into the emitter portion of the system. For clarity, the overall wavelength range applied for output extends from a first wavelength λ1 to a final wavelength λn, where λ1<λn. Each wavelength range is shown to be contiguous over this overall range of λ1 to λn, such as from λ1 to λ2, from λ2 to λ3, and so on to λn−1 to λn. While a nominally contiguous range is particularly suitable, such is not necessarily required; for example, ranges of λ1 to λ2, λ3 to λ4, and so on up to λn−1 to λn can be used so there are gaps between each range. In still other embodiments, each laser can output a nominally constant wavelength (e.g., the first laser outputs λ1, the second laser outputs λ2, the last laser outputs λn, and so on for the n lasers), and these wavelengths, within normal variations, are supplied to the system.

As noted above, the values/ranges of the various multiple wavelengths of the emitted light pulses can vary depending on the requirements of a given application. In some embodiments, the differential ranges of values output by each laser may be on the order of from about 5-10 nm, although other ranges can be used. For clarity, all of the wavelengths may be centered around some nominal operational LiDAR wavelength (e.g., 850 nm, 1550 nm, etc.).

Continuing with FIG. 6, the outputs of the respective lasers 602 are supplied to a corresponding array of 1×2 splitters 604, which direct a portion of the input light signals to a multiplexer (mux) 606. The mux 606 combines the input signals to provide a combined output multiplexed beam that is randomized via phase modulation using a phase modulator 608 which in turn is controlled using a pseudorandom bit sequencer (PRBS) circuit 610.

The PRBS circuit 610 is a random number source that outputs a random number. The random number can be a true random number, a pseudorandom number, an otherwise sufficiently random to be indistinguishable from white noise levels of randomness number, etc. Those skilled in the art will recognize that randomness is a function of entropy, so what is described herein is a system that produces or uses entropy at a sufficiently high level to accomplish the desired function of, over time, a sufficiently randomized output of the various wavelengths in an unpredictable sequence or manner. Any suitable number of hardware, software or firmware based random number generator systems can be used (including ring oscillators, etc.) as the PRBS circuit. The introduction of randomness mixes the characteristics (e.g., wavelengths, etc.) of the pulses output by the system to produce a randomized, multiplexed beam.

Once generated, the output beam is passed through another 1×2 splitter 612 to an OPA 614 to scan the FoV with randomly selected wavelengths that are simultaneously scanned as described above.

The splitters 604 are used to provide signals as part of the detection process, which uses a multi-channel arrangement with demultiplexer 616, 2×4 splitters 618, balanced photodetector (PD) pairs 620 and signal processing block 622. This scheme multiplexes the lasers immediately and phase modulate all wavelengths with a single phase shifter/PRBS, and then demultiplexes the return signal and detects a separate electronic signal for each wavelength.

The embodiment of FIG. 6 operates upon multiple wavelengths which are multiplexed into a single OPA, and demultiplexed and combined with appropriate local oscillators in 90° hybrids. This scheme utilizes multiple separate lasers, each of which is responsible for a separate wavelength range. The local oscillator is immediately split off from each laser, while the rest of the light is multiplexed, modulated, randomized, and sent to the OPA. Half the return light is routed through the 1×2 splitter into the demultiplexer, where each wavelength is combined with the appropriate local oscillator in a 2×4 90° hybrid, and then fed into a pair of balanced photodetectors, and then the electrical signal is sent to signal processing.

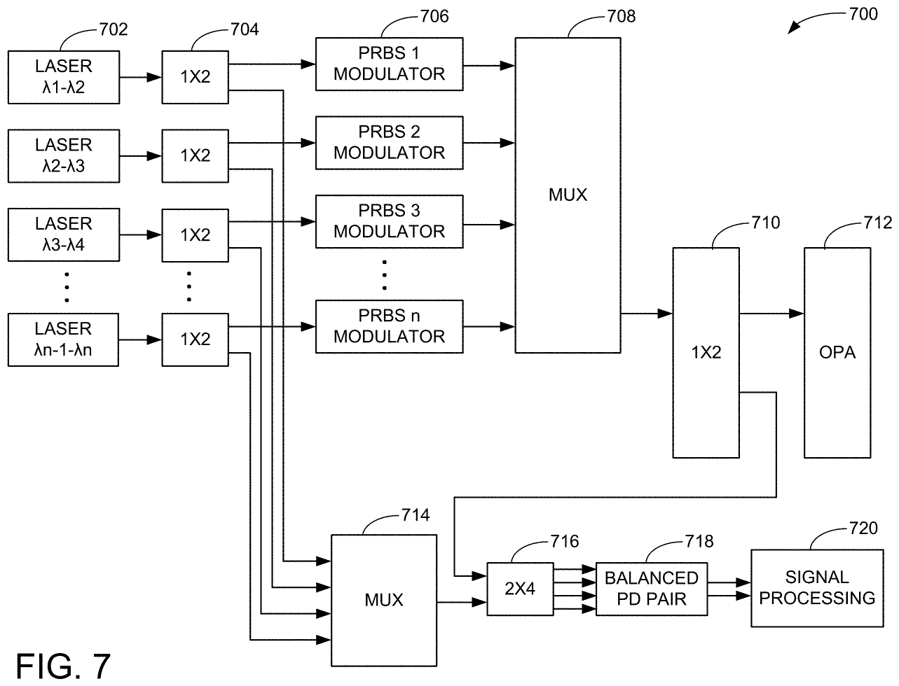

FIG. 7 provides an alternative configuration for an emitter and detector circuit 700 that also uses multiple lasers 702. In this case, the randomization is applied individually to each input wavelength channel via 1×2 splitters 704, PRBS modulators 706 and mux 708.

The output of the mux 708 is again split via 1×2 splitter 710 with half of the signal directed to an OPA 712 for scanning as before, and the other half of the signal supplied to a detection channel. The channel has an input mux 714, 2×4 splitter 716, balanced PD stage 718 and signal processing block 720.

Each wavelength channel is modulated using a different PRBS pattern. The resulting wavelengths are multiplexed onto one channel, and the detection is performed on that multiplexed waveguide. Each wavelength will be encoded with a different PRBS, and the signal processing can correlate the one electronic signal against each PRBS in turn to recover the information from each separate channel.

In this way, the embodiment of FIG. 7 operates to multiplex multiple wavelengths onto a single OPA and then use single a balanced PD pair to yield the entire signal. This scheme utilizes multiple separate lasers, each of which is responsible for a separate wavelength range.

The local oscillator is immediately split off from each laser and routed into a wavelength multiplexer. The remaining light is then sent through the n separate phase modulators, each of which is modulated by a different PRBS signal. Each of these channels are then multiplexed and sent to an OPA, and the return light is sent into a single 2×4 detector.

The wavelength difference between different lasers will be great enough (>1 nm scale to get angular separation via OPA) that interference between multiple wavelengths will be far too fast for the photodetectors to pick up and will therefore be filtered out. The signal processing will be correlating with the n different PRBS signals, and the correlation will produce a spike only on the specified channel, which will allow each channel to be processed independently in spite of sharing the same detection electronics.

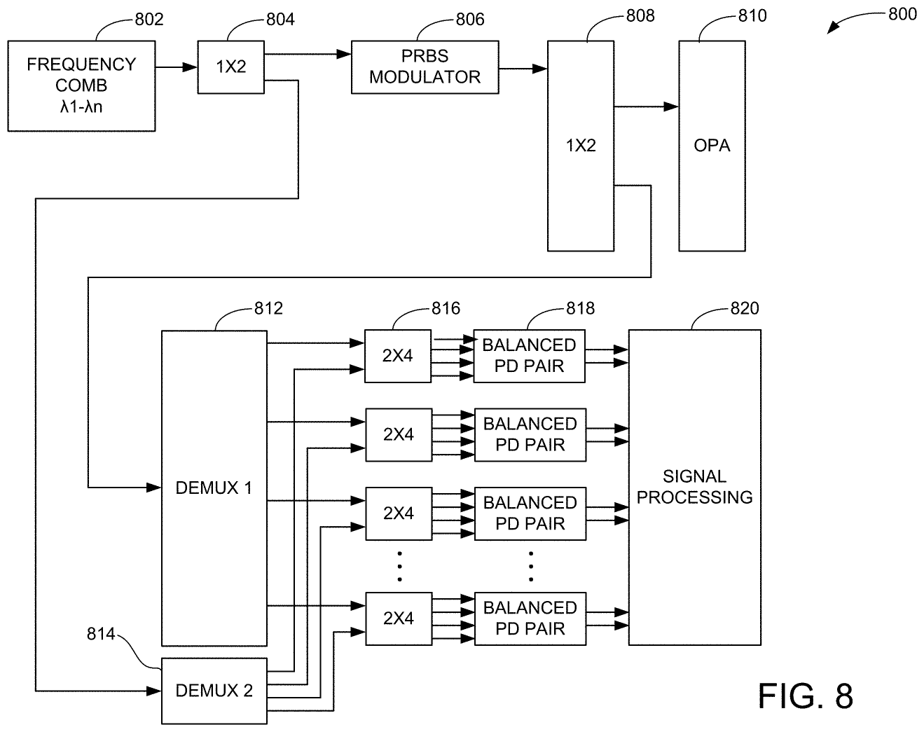

Another approach to generating multiple wavelengths is to use a frequency comb laser arrangement, as provided in FIG. 8. As will be recognized, frequency combs are lasers which generate a coherent pulse train of light, which is also a broadband pulse train in frequency space. Such a laser therefore generates many wavelengths from a single device, which can help forgo the need to multiplex light from separate laser sources before being routed to the OPA.

Emitter and detection circuitry 800 in FIG. 8 includes a frequency comb 802 which feeds a 1×2 splitter 804, PRBS modulator 806, a second 1×2 splitter 808 and OPA output device 810. Detection processing uses first and second demodulators 812 and 814 (Demux 1 and 2), and n detection channels each with a 2×4 splitter 816 and balanced PD stage 818. The respective channels are decoded using a signal processing block 820. The scheme used by FIG. 8 provides one electronic signal per wavelength channel.

In the embodiment of FIG. 8, the frequency comb laser outputs multiple wavelengths, the local oscillator is immediately split off, and the rest of the light goes through the modulator and to the OPA for scanning. The return light is collected and demultiplexed, along with the local oscillator. Each wavelength channel is then mixed and detected electronically and sent to the signal processing block as shown.

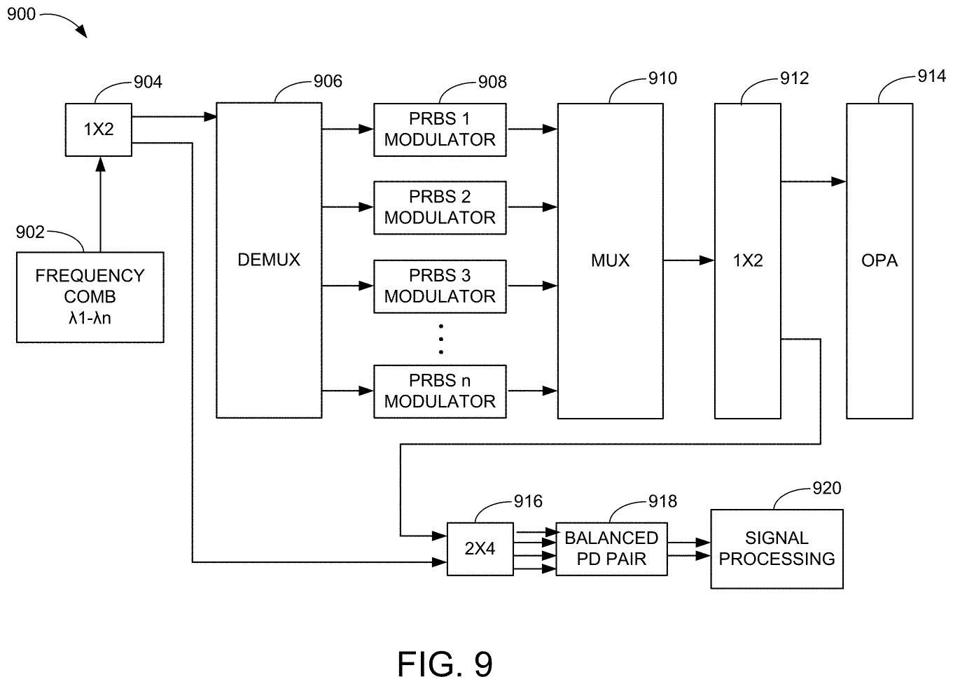

FIG. 9 provides emitter and detection circuitry 900 as an alternative frequency comb based arrangement. In this embodiment, frequency comb 902 feeds 1×2 splitter 904, demux 906 and separate emitter channels each with a separate PRBS modulator circuit 908, mux 910, 1×2 splitter 912 and OPA 914. A single detection channel receives the input signal to the OPA 914 and combines with the output from the frequency comb 902 at 2×4 splitter 916. The output of the splitter is processed by PD stage 918 and signal processing block 920. In this way, a different PRBS is encoded on each wavelength channel.

The embodiment of FIG. 9 also uses a frequency comb, but in this case the light is first demultiplexed into multiple separate waveguide channels, and each channel is modulated with a separate PRBS signal before being multiplexed back into a single waveguide. This light is then sent to the OPA scanner and the multiwavelength return light is mixed with the multiwavelength local oscillator in the single broadband 2×4 mixer, which is then detected by the balanced PD pair. The signal processing scheme then correlates the detected optical signal with each PRBS.

The foregoing alternative embodiments of FIGS. 6-9 are merely exemplary and are not necessarily limiting. Other multiple laser and single frequency comb laser configurations will readily occur to the skilled artisan in view of the present disclosure.

As noted above, an advantage of multiple wavelength-separated beams in coherent LiDAR as disclosed and embodied herein is that the integration time can be increased, which will both increase the dwell time on a particular point, which will enable higher ranges, as the system can afford to wait for longer for the light to travel to and from a target that is potentially hundreds of meters away. Additionally, it allows a higher effective power to be transmitted through the system because the power is spread throughout the optical spectrum which will not produce lossy two-photon effects. Finally, this approach can potentially allow the relaxing of at least some of the requirements on the scanning lasers, as the system will only require multiple lasers that can wavelength scan over a relatively small spectrum (e.g., 5-10 nm) versus a single laser that can scan a relatively larger spectrum (e.g., over 60-100 nm, etc.).

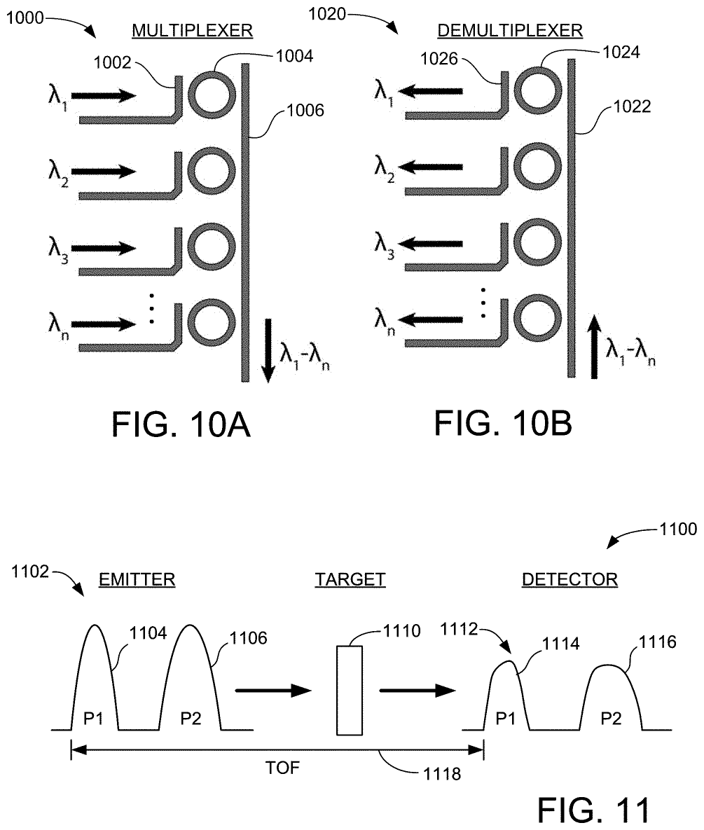

FIGS. 10A and 10B show respective multiplexer (mux) 1000 and demultiplexer (demux) 1020 arrangements that can be utilized in the various circuits described above. These devices utilize micro-resonance ring (MRR) configurations, although other coupling arrangements can be used. The transfer characteristics of MRRs is well understood by those skilled in the art, so a detailed description of the operation is not provided other than as follows.

An MRR is tuned to respond to a particular range of resonant frequencies, so that components of an input signal having the associated resonant frequencies presented to a first waveguide in close proximity and therefore coupled to a first side of the ring are transferred, via the ring, into an output signal on a second waveguide that is also in close proximity to and therefore also coupled to the ring.

Stated another way, an MRR arrangement generally operates as a filter or selection circuit to transfer components of a signal that match the resonance characteristics of the ring. Those components of an input multi-spectrum signal that are sufficiently close to the resonance frequency of the ring are transferred across the gap provided by the ring from the input waveguide to the output waveguide, while other components of the multi-spectrum input signal continue to pass along the input waveguide and are not transferred to any output waveguide in the system.

The mux 1000 in FIG. 10A includes a sequence of input waveguides 1002 and intervening micro-rings 1004 coupled to a common output waveguide 1006. As described above, each ring has a different resonance response characteristic associated with a different wavelength range. The response is controlled by a number of factors including but not limited to the overall circumferential length of the ring, input bias voltages, etc. The mux operates by each wavelength coming near the rings and coupling into the single output waveguide. A different stage operates over each different wavelength range.

The demux circuit 1020 in FIG. 10B is configured similarly, but operates in the opposite direction as compared to the mux circuit 1000 in FIG. 10A. The demux circuit 1020 has a single input waveguide 1022, a series of intervening micro-rings 1024, and individual output waveguides 1026 for each respective wavelength range. In this case, a multi-spectral multiplexed beam is supplied along the input waveguide 1022, and via resonance coupling of the various MRRs 1024, individual components at different frequency ranges are output along the output waveguides 1026.

FIG. 11 shows a pulse transmission and reflection sequence 1100 carried out in accordance with various embodiments. An initial set of pulses is depicted at 1102 having two pulses 1104, 1106 denoted as P1 and P2. Each pulse may be provided with a different associated wavelength or have other characteristics to enable differentiation by the system as described above. The emitted pulses 1104, 1106 are quanta of electromagnetic energy that are transmitted downrange toward a target 1110. One or more pulses may correspond to each beam point shown in the FoV 520 in FIG. 5C.

Reflected from the target is a received set of pulses 1112 including pulses 1114 (pulse P1) and 1116 (pulse P2). The time of flight (TOF) value for pulse P1 is denoted at 1118. Similar TOF values are provided for each pulse in turn.

The received P1 pulse 1114 will likely undergo frequency Doppler shifting and other distortions as compared to the emitted P1 pulse 1104. The same is generally true for each successive sets of transmitted and received pulses such as the P2 pulses 1106, 1116. Nevertheless, the wavelengths, frequencies, phase and amplitudes of the received pulses 1114, 1116 will be processed as described above to enable the detector circuit to correctly match the respective pulses and obtain accurate distance and other range information.

In some cases, the emitted/received pulses such as P1 can represent pulses at a first wavelength and the emitted/received pulses such as P2 can represent pulses at a different, second wavelength. Different frequencies, wavelengths, amplitudes, gain characteristics, pulse sequence counts, and other adjustments can be made to further distinguish and process the respective pulses in the various areas.

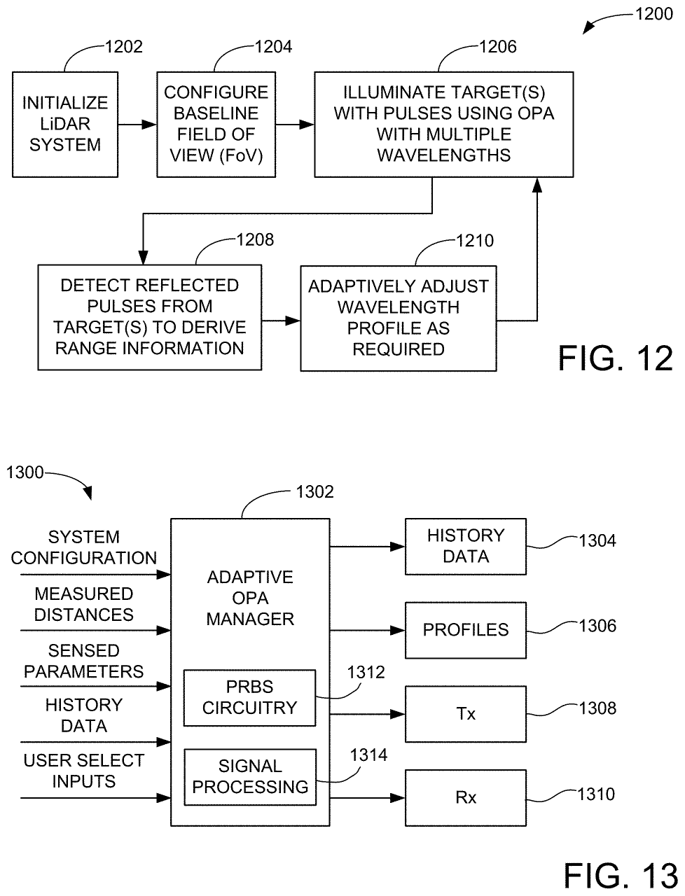

FIG. 12 is a sequence diagram 1200 for a multiwavelength scan operation carried out in accordance with various embodiments as described herein. Other operational steps can be incorporated into the sequence as required, so the diagram is merely illustrative and is not limiting.

A LiDAR system such as 100 in FIG. 1 is initialized at block 1202. An initial, baseline field of view (FoV) is selected for processing at block 1204. This may include the selection and implementation of various parameters (e.g., pulse width, wavelength, raster scan information, density, etc.) to accommodate the baseline FoV. In at least some cases, a particular profile of different wavelengths to be emitted will be selected during this configuration operation.

Thereafter the system commences with normal operation at block 1206. Light pulses are transmitted to illuminate various targets within the FoV as described above using the emitters as variously described above. Reflected pulses from various targets within the baseline FoV are detected at block 1208 using a detector system as provided above. The detected pulses are subjected to signal processing to derive range information associated with the illuminated targets.

As required, adaptive adjustments are made to the operation of the system at block 1210. These adjustments can be made as a result of target range information obtained by block 1208, or based on other inputs such as from external sensors (see e.g., FIG. 1), user selected inputs, and so on. The adjustments at block 1210 change the wavelength profile being used to scan the FoV, and can include different ranges of wavelengths as well as other parametric changes. Thereafter, the routine returns to block 1206 for further scanning using the newly selected profile.

FIG. 13 provides an adaptive management system 1300 that can be incorporated into the system 100 of FIG. 1 in some embodiments. The system 1300 includes an adaptive OPA manager circuit 1302 which operates to implement the multiwavelength scans in the selected fields of interest within a baseline FoV as described above. The manager circuit 1302 can be incorporated into the controller 104 such as a firmware routine stored in the local memory 124 and executed by the controller processor 122.

The manager circuit 1302 uses a number of inputs including system configuration information, measured distance for various targets, various other sensed parameters from the system (including external sensors 126), history data accumulated during prior operation, and user selectable inputs. Other inputs can be used as desired.

The manager circuit 1302 uses these and other inputs to provide various outputs including accumulated history data 1304 and various profiles 1306, both of which can be stored in local memory such as 124 for future reference. The history data 1304 can be arranged as a data structure providing relevant history and system configuration information. The profiles 1306 can describe different pulse set configurations at different wavelengths as well as other parameters such as pulse counts, amplitude and gain levels, ranges and slopes for different sizes, types, distances and velocities of detected targets, etc.

The manager circuit 1302 further operates to direct various control information to an emitter (transmitter Tx) 1308 and a detector (receiver Rx) 1310 to implement these respective profiles. It will be understood that the Tx and Rx 1308, 1310 correspond to the various emitters and detectors described above. As desired, the manager circuit 1302 can further include PRBS circuitry 1312 and signal processing circuitry 1314 which operate as described above.

It can now be understood that various embodiments provide a LiDAR system with the capability of emitting light pulses over a selected FoV using one or more OPA type devices that process multiwavelength scans along one or more directions. Any number of different alternatives will readily occur to the skilled artisan in view of the foregoing discussion.

While coherent, I/Q based systems have been contemplated as a basic environment in which various embodiments can be practiced, such are not necessarily required. Similarly, while solid-state OPA outputs are particularly suitable for various embodiments, in alternative configurations other types of output systems can be employed, including mechanical systems such as galvanometers or rotatable polygons, micromirror technology, etc.

It is to be understood that even though numerous characteristics and advantages of various embodiments of the present disclosure have been set forth in the foregoing description, together with details of the structure and function of various embodiments of the disclosure, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. A light detection and ranging (LiDAR) system comprising:
an emitter configured to emit light in the form of multiplexed beams of randomized, multiple wavelengths across a field of view (FoV); and
a detector having one or more detection channels configured to simultaneously detect the multiplexed beams reflected from a target within the FoV to decode range information associated with the target.

2. The system of claim 1, wherein the emitter comprises a random number source which outputs a random bit sequence which is applied to the multiplexed beams to randomize the wavelengths emitted by the emitter.

3. The system of claim 1, wherein the emitter comprises a plurality of light sources each simultaneously outputting a portion of the beams at a different one of the multiple wavelengths.

4. The system of claim 3, further comprising a multiplexer which receives and combines each of the beams from the plurality of light sources to generate the multiplexed beams.

5. The system of claim 1, wherein the emitter comprises a frequency comb configured to simultaneously output each of the different multiple wavelengths.

6. The system of claim 1, wherein the emitter further comprises an optical phase array (OPA) integrated circuit (IC) device configured to sweep the multiplexed beams across the FoV along at least one direction.

7. The system of claim 5, wherein the OPA IC device sweeps the multiplexed beams across the FoV along two orthogonal directions.

8. The system of claim 1, further comprising at least one multiplexer (mux) comprising a plurality of input waveguides coupled to a unitary output waveguide by an intervening corresponding number of micro-resonance rings (MRRs), each MRR configured to resonate at a different one of the multiple wavelengths.

9. The system of claim 1, further comprising at least one demultiplexer (demux) comprising a unitary input waveguide coupled to a plurality of output waveguides via an intervening corresponding number of MRRs, each MRR configured to resonate at a different one of the multiple wavelengths.

10. The system of claim 1, further comprising at least one splitter configured to send a first portion of the multiplexed beams to an output device for emission toward the target and a second portion of the multiplexed beams to the detector to provide single or multi-channel I/Q decoding.

11. The system of claim 1, wherein the detector comprises at least one balanced pair of photodetectors (PDs) to convert the beams to an electrical analog signal for processing by a signal processing circuit.

12. The system of claim 1, wherein a first configuration of multiplexed beams is emitted in a direction toward the target within the FoV, and wherein a different, second configuration of multiplexed beams is subsequently emitted in a direction toward the target within the FoV, the second configuration selected responsive to the range information decoded from the target using the first configuration.

13. A method of performing light detection and ranging (LiDAR), comprising steps of:
generating a plurality of beams of light each at a different wavelength;
combining, using a randomization function, the plurality of beams to generate a multiplexed beam;
emitting the combined multiplexed beam toward a target within a field of view (FoV); and
simultaneously detecting the respective wavelengths from the multiplexed beam reflected from the target to decode range information associated with the target.

14. The method of claim 13, wherein the randomization function is a pseudorandom bit sequence (PRBS) which is applied to the multiplexed beam.

15. The method of claim 13, wherein each of the plurality of beams of light are generated by a different one of a corresponding plurality of laser based devices configured to output light over a different wavelength range.

16. The method of claim 13, wherein each of the plurality of beams of light are generated by a frequency comb source.

17. The method of claim 13, further comprising using a multiplexer to receive and combine each of the beams from the plurality of light sources to generate the multiplexed beams, the multiplexer comprising a plurality of input waveguides, a unitary output waveguide, and a plurality of micro-resonance rings (MRRs) each configured to resonate at the associated wavelength to transfer the beams to the unitary output waveguide.

18. The method of claim 13, further comprising using an optical phase array (OPA) integrated circuit (IC) device to sweep the combined multiplexed beam across the FoV along at least one direction.

19. The method of claim 18, further comprising using a splitter to divert a first portion of the combined multiplexed beam to the OPA IC device and a remaining second portion of the combined multiplexed beam to at least one channel of a detector circuit configured to provide I/Q decoding.

20. The method of claim 13, wherein a first configuration of multiplexed beams is emitted in a direction toward the target within the FoV, and wherein a different, second configuration of multiplexed beams is subsequently emitted in a direction toward the target within the FoV, the second configuration selected responsive to the range information decoded from the target using the first configuration.
